(19) United States
(12) Patent Application Publication
(10) Pub. No.: US 2004/0188215 A1
(43) Pub. Date: Sep. 30, 2004

(54) Friction clutch

(75) Inventors: Michael Istschenko, Schweinfurt (DE); Werner Selzam, Wipfeld (DE); Horst Friedrich, Aidhausen (DE)

Correspondence Address: COHEN, PONTANI, LIEBERMAN & PAVANE, 551 FIFTH AVENUE, SUITE 1210, NEW YORK, NY, 10176, US

(73) Assignee: Sachs Race Engineering GmbH

(21) Appl. No.: 10/783,194

(22) Filed: Feb. 20, 2004

(30) Foreign Application Priority Data
Feb. 20, 2003 (DE) 103 07 143.1

(51) Int. Cl. F16D 13/70

(52) U.S. Cl. 192/70.27; 192/89.24; 192/107 R

(57) ABSTRACT

A friction clutch includes a housing arrangement connectable to a drive element for rotation in common about an axis of rotation, a pressure plate connected to the housing arrangement such that the pressure plate is fixed with respect to rotation relative to the housing arrangement and axially movable relative to the housing arrangement, a force-exerting arrangement acting on a first axial side of the pressure plate to produce the engaged state of the friction clutch, and a friction disk connected to the housing arrangement such that the friction disk is fixed with respect to rotation relative to the housing arrangement and is axially movable relative to the housing arrangement. The friction disk has a ring-shaped friction lining carrier on which the second axial side of the pressure plate acts in the engaged state. The friction lining carrier carries at least one friction lining element on the axial side facing away from the pressure plate. The friction disk is connected to the pressure plate such that the movement of the friction disk in the direction away from the second axial side of the pressure plate is limited.

### BACKGROUND OF THE INVENTION

1. Field of the Invention

The present invention relates to a friction clutch comprising a housing arrangement connectable to a drive element for rotation in common about an axis of rotation, a pressure plate connected to the housing arrangement such that the pressure plate is fixed with respect to rotation and axially movable relative to the housing arrangement in the direction parallel to the axis of rotation, a force-exerting arrangement acting on a first axial side of the pressure plate to produce an engaged state, and a friction disk connected to the housing arrangement such that the friction disk is fixed with respect to rotation relative to the housing arrangement and axially movable relative to the housing arrangement, wherein the friction disk has a ring-shaped friction lining carrier on which the second axial side of the pressure plate acts in the engaged state of the friction clutch.

2. Description of the Related Art

U.S. Pat. No. 5,904,234 discloses a multi-disk friction clutch. Because these clutches have several friction disks, each with its own set of friction surfaces, this type of clutch is suitable for applications in which very high torques must be transmitted. Some of these disks are assigned to the housing arrangement, others to the hub. The corresponding increase in the overall size of the effective frictional surface area provides these clutches with the ability to transmit correspondingly high torques. These types of clutches are used in, for example, racing vehicles and sports cars.

In this type of clutch, special friction linings may be provided on at least one of the friction disks to properly handle the torques transmitted. These special friction linings, in conjunction with suitable friction partners, result in a further increase in the torque which can be transmitted. The friction disk acted upon in the engaged state by the pressure plate (either directly or via an intermediate element), i.e., the disk in the stack of friction disks which is closest to the pressure plate, is frictionally active on only one axial side. The other axial side is, or enters into, direct contact with the pressure plate. For this reason, no friction-lining elements are attached to the side of the friction disk which faces the pressure plate. This also has the especially advantageous effect of reducing the amount of axial space which this friction disk occupies. The result is therefore that a friction disk of this type has an asymmetrical design in the axial direction, because a friction lining is present only on one axial side of the ring-shaped friction lining carrier.

The asymmetric design of the friction disk adjacent the pressure plate causes no basic problems with the frictional engineering involved. However, the asymmetric design of the friction disk mentioned above has the result that the friction disk has the tendency to become deformed, i.e., to bulge out or to assume an umbrella-shaped configuration, when clutch-disengaging operations are performed—especially when they are performed at high rpm's—and the friction disk is in a state in which the pressure plate is exerting little or no force on it. This is attributable to the effect of the centrifugal forces which act on the minimum of one friction lining element. This deformation of the friction disk leads in turn to the result that the friction disk which is being deformed by the action of centrifugal force uses up at least some of the axial play created by the ability of the pressure plate to shift in the axial direction during a clutch-release operation, which enables the individual friction disks interacting frictionally with each other to separate from each other. This requires that a larger amount of space must be made available to the pressure plate in the axial direction to compensate for the increase in the axial dimension of the friction disk which occurs during the clutch-release operation. The larger amount of space causes the disengagement time of the clutch to increase. This is a significant disadvantage especially in sports cars.

### SUMMARY OF THE INVENTION

The object of the present invention is to provide a friction clutch in which the problems caused by the action of centrifugal forces on the friction disks are avoided.

The object is met by a friction clutch according to the present invention comprising a housing arrangement connectable to a drive element for rotation in common about an axis of rotation, a pressure plate connected to the housing arrangement such that the pressure plate is fixed with respect to rotation relative to the housing arrangement and axially movable relative to the housing arrangement, a force-exerting arrangement acting on a first axial side of the pressure plate to produce the engaged state of the friction clutch, and a friction disk connected to the housing arrangement such that the friction disk is fixed with respect to rotation relative to the housing arrangement and is axially movable relative to the housing arrangement. The friction disk has a ring-shaped friction lining carrier on which the second axial side of the pressure plate acts in the engaged state. The friction lining carrier carries at least one friction lining element on the axial side facing away from the pressure plate. The friction disk is connected to the pressure plate such that the movement of the friction disk in the direction away from the second axial side of the pressure plate is limited.

In the friction clutch according to the invention, the friction disk with an asymmetric design is supported against the pressure plate and is in fact prevented from moving away from it. Therefore, the centrifugal forces acting on the friction disk cannot deform it or can deform it only to the extent allowed. Because the pressure plate is in itself a comparatively massive component, usually made of steel, titanium, or some other metal, it can absorb the forces which act on the friction disk and which would otherwise deform it without the danger that the pressure plate itself could suffer similar deformation.

In a friction clutch according to the invention, the second axial side of the pressure plate may be provided with an actuating surface which is configured such that, in the relaxed state of the pressure plate, a surface normal of at least certain areas of the actuating surface is not parallel to the axis of rotation. The actuating surface is preferably conical. This special configuration of the pressure plate has the result that, upon performance of a clutch-engaging operation, the pressure plate does not, at first, make full contact over its entire surface with, for example, the friction disk or an intermediate disk installed between the pressure plate and the friction disk. This full-surface contact is established only gradually as the tension on the pressure plate increases. The functionality of an elastic suspension for the linings known from conventional friction clutches may therefore be incorporated into the pressure plate. So that the friction disk may also be supported by a pressure plate with the above-described configuration without impairment of the ability of the pressure plate itself to undergo the desired deformation, the friction disk may be connected to the pressure plate such that relative movement between these two assemblies is possible. During the relative movement between the friction disk and the pressure plate, the pressure plate changes between a tensioned state, in which the actuating surface assumes the same shape as that of the actuated element, preferably the friction lining carrier, and the relaxed state.

It should be pointed out here that the relaxed state of the pressure plate may be a state in which it is relaxed to such an extent that it no longer has any tensioning forces of its own. The relaxed state may also be a state which is produced when the connection between the pressure plate and the friction lining carrier goes into effect, as a result of which the pressure plate is prevented from relaxing completely during the performance of a clutch-release operation. The axial connection between the pressure plate and the friction disk may be achieved by providing a plurality of connecting elements which connect the friction lining carrier axially to the pressure plate. To allow mobility or deformability of the pressure plate between the relaxed state and the tensioned state, the connecting elements may be permanently connected to the friction lining carrier and have enough play with respect to the pressure plate to provide a certain freedom of relative movement. In addition, the connecting elements may be supported in the axial direction on the pressure plate when the pressure plate is in the relaxed state.

In accordance with a very easy-to-manufacture but nevertheless reliably functioning embodiment, at least one of the connecting elements is designed as a stepped rivet. A section of the stepped rivet having a smaller diameter passes through the friction lining carrier and a section of the stepped rivet having a larger diameter passes through the pressure plate. The friction lining carrier is thus held in position between the larger-diameter section and a first rivet head adjacent to the smaller-diameter section. A second head of the rivet adjacent to the larger-diameter section may be supported against the axial side of the pressure plate facing away from the friction lining carrier.

A plurality of friction disks connected to the housing arrangement for rotation in common around the axis of rotation but with freedom of movement in the direction parallel to the axis of rotation may be provided so that the greatest possible torque may be transmitted by the friction clutch according to the present invention. At least one of the plural friction disks may be connected to a hub for rotation in common around the axis of rotation and with freedom to move in the direction parallel to the axis of rotation is always present between two friction disks connected to the housing arrangement. It is also possible for at least one friction disk connected to the housing arrangement to have a ring-like friction lining carrier with at least one friction lining element attached to each axial side.

The force-exerting arrangement used in the friction clutch according to the present invention can comprise an energy-storage device, such as a diaphragm spring or a plate spring, which is supported against the pressure plate and the housing arrangement.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a longitudinal cross-sectional view of a friction clutch according to the present invention;

FIG. 2 is an axial end view of a friction disk used in the friction clutch of FIG. 1;

FIG. 3 is a cross-sectional view of the friction disk of FIG. 2 along line III-III of FIG. 2;

FIG. 4 is an axial view of an assembly consisting of the friction disk of FIG. 2 and a pressure plate of the friction clutch shown in FIG. 1;

FIG. 5 is a cross-sectional view of the assembly shown in FIG. 4 along line V-V in FIG. 4; and

FIG. 6 is an enlarged view of the detail within the circled area marked VI in FIG. 5.

### DETAILED DESCRIPTION OF THE PRESENTLY PREFERRED EMBODIMENTS

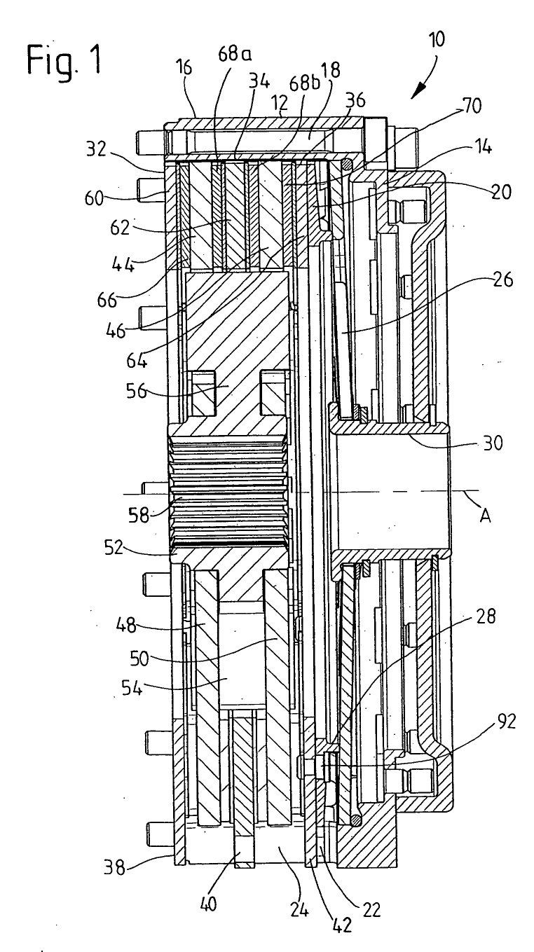

A friction clutch 10 according to the present invention is shown in FIG. 1. The friction clutch 10 comprises an essentially ring-shaped housing arrangement 12 with a housing bottom area 14 having an essentially ring-shaped structure at one axial end. In the example shown here, the bottom area 14 is formed as an integral part of an outer, essentially cylindrical area 16 of the housing arrangement 12. It is obvious that the bottom area 14 could also be made separately from the cylindrical area 16 and connected permanently to it by screw bolts 18, which simultaneously connect the housing arrangement 12 to a flywheel (not shown in the figures).

A pressure plate 20 with a ring shape is arranged inside the housing arrangement 12. A radially outer part of the pressure plate 20 has a driver formation 22 which engages a corresponding opposing driver formation 24 on the cylindrical area 16 of the housing arrangement 12 so that the two components rotate in common. Although the pressure plate 20 is connected so that it is essentially unable to rotate relative to the housing arrangement 12, the pressure plate 20 is free to move relative to the housing arrangement 12 in the direction parallel to an axis of rotation A. An energy-storage device, designed here as a diaphragm spring 26, is supported in its radially outer area against the housing arrangement 12, specifically in the area of the transition between the bottom area 14 and the essentially cylindrical area 16. The diaphragm spring 26 is also supported on a blade area 28 of the pressure plate 20. A clutch release mechanism 30, shown only schematically, pulls on the radially inner end of the diaphragm spring 26 to disengage the friction clutch 10.

The friction clutch 10 shown in FIG. 1 also has three friction disks 32, 34, 36, which, like the pressure plate 20, have their own driver formations 38, 40, 42, and are thus connected nonrotatably to the opposing driver formation 24 on the housing arrangement 12. Each of the three friction disks 32, 34, 36 has freedom to shift relative to the housing arrangement 12 in the direction parallel to the axis of rotation. A friction disk 44 is located between the two friction disks 32 and 34. Another friction disk 46 is located between the two friction disks 34 and 36. Each of the two friction disks 44, 46 has a driver formation 48, 50 in its radially inner area. In the area of these driver formations 48, 50, the two friction disks 44, 46 engage for rotation in common with connecting arms 54 arranged on a hub 52 and which extend radially outward in an essentially star-like manner. The friction disks 44, 46 are thus connected in an essentially nonrotatable manner to the hub 52 but are also connected such that they are movable with respect to the hub 52 in at least one axial direction. An axial securing area 56 of the hub 52 extends radially inside the connecting arms 54 to ensure that the hub 52 is held in position in the axial direction with respect to the friction disks 44, 46. The inner circumferential area of the hub 52 has a set of wedge-shaped teeth 58 so that the hub may be connected nonrotatably to a power takeoff shaft or other driven shaft.

In the engaged state, the diaphragm spring 26 exerts an engaging force on the pressure plate 20 and the pressure plate 20 exerts pressure on the friction disk 36 located immediately adjacent to it in the axial direction. Because both the pressure plate 20 and the friction disk 36 are connected nonrotatably to the housing arrangement 12, no friction acting in the circumferential direction is produced between these two components. The friction disk 36 is pressed against the friction disk 46 connected to the hub 52, which latter disk is pressed in turn against the friction disk 34 connected nonrotatably to the housing arrangement 12. The friction disk 34 in turn exerts force on the friction disk 44 connected to the hub 52. This friction disk 44 acts on the last friction disk 32 connected to the housing arrangement 12, which latter disk then is supported axially against a flywheel (not shown). Because no relative rotation is possible between the flywheel and the friction disk 32, only static axial contact is present here, as in the case between the pressure plate 20 and the friction disk 36.

In the friction clutch 10 shown in FIG. 1, the friction disks 32, 34, 36 connected nonrotatably to the housing arrangement 12 are arranged so that each has its own ring-shaped friction lining carrier 60, 62, 64. In the area where the associated friction disks 32, 34, 36 are connected for rotation in common to the housing arrangement 12, the friction lining carriers 60, 62, 64 carry a plurality of friction lining elements 66, 68a, 68b, 70, which are in the form of segments of a circle. The friction lining elements 66, 68a, 68b, 70 are on the sides of the carriers 60, 62, 64 which face the friction disks 44, 46 of the hub 52. Therefore, only the friction disk 34 has a friction lining element 68a, 68b on both axial sides of the friction lining carrier 62, because each axial side of friction disk 34 faces a friction disk of the hub 52, i.e., friction disk 44 on one side and friction disk 46 on the other. The other two friction disks 32, 36, which are situated in the axial end areas and which therefore are frictionally active on only one axial side, have a group of friction lining elements 66, 70 on only this one axial side.

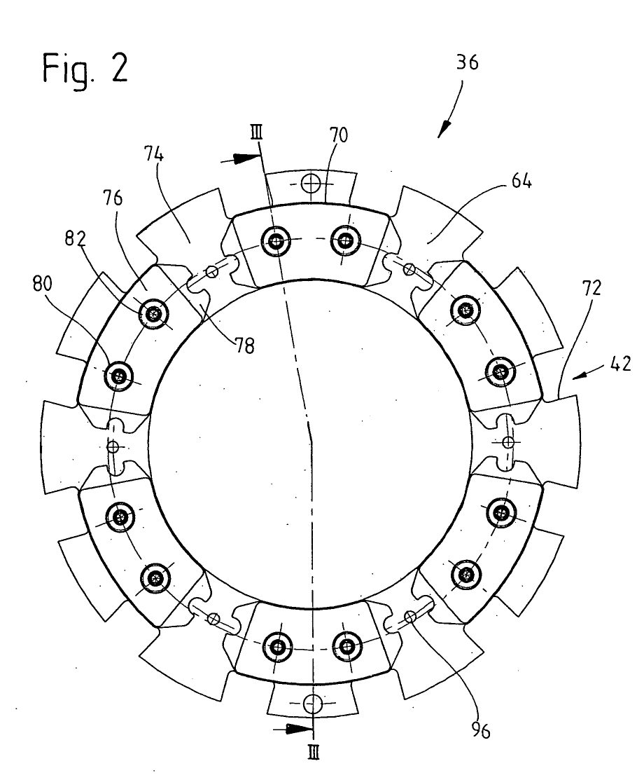

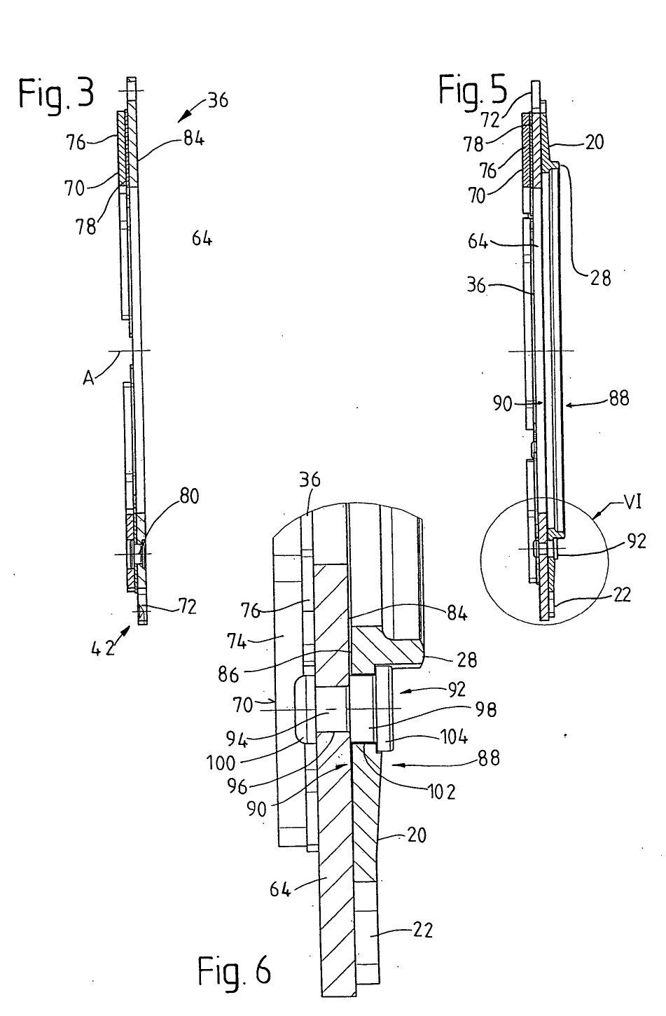

FIGS. 2 and 3 show the friction disk 36 which is axially adjacent to the pressure plate 20. Friction disk 36 may be essentially identical in design to the friction disk 32 and simply installed in reversed position in the housing arrangement 12. The radially outer area of the ring-like friction lining carrier 64 has notches or recesses 72 which form the driver formation 42 and thus provide for the nonrotatable connection between the friction disk 36 and the housing arrangement 12. On the axial side 74 facing away from the pressure plate 20, the friction disk 36 carries individual friction lining elements 70. Each of the friction lining elements 70 can have a friction material body 76 made out of a special friction material such as, for example, carbon. The friction lining bodies 76 being permanently connected by an adhesive to a plate-like carrier 78. These assemblies, which include the friction lining bodies 76 and plate-like carrier 78, are then fastened in place to the friction lining carrier 64 by clinch bolts 80, 82, which, in the example shown here, are located in the area of the friction material body 76 and pass through this body and also the friction lining carrier 64. It should be pointed out that this connection could also be accomplished by riveting the carrier plate 78 to the friction lining carrier 64. In this way, a ring-like grouping of friction lining elements 70 is produced, which can enter into frictional contact with the opposing friction disk 46 of the hub 52. The friction disk 46 may also be made out a friction material such as carbon or steel which has been optimized with respect to the desired frictional properties. It should be pointed out that the friction lining elements 68a, 68b may also be attached in the same way to the friction lining carrier 62 of the friction disk 34 located in the middle.

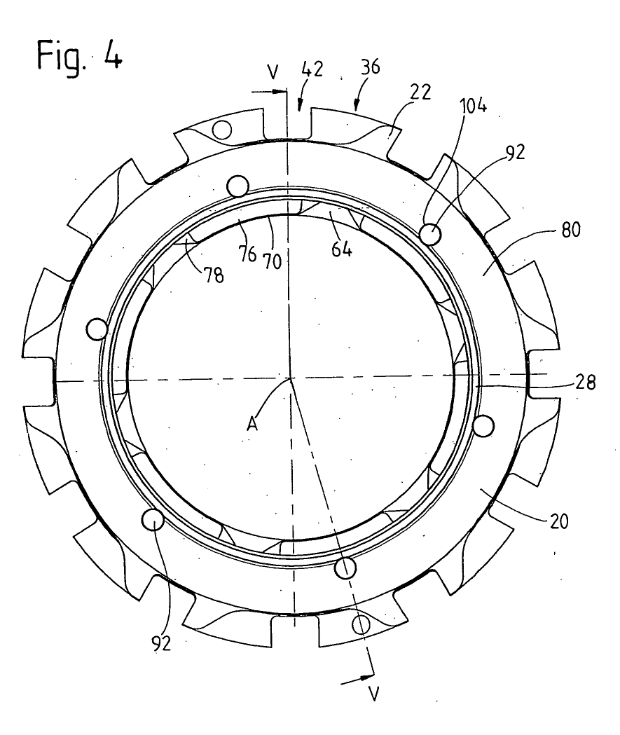

FIG. 3 shows that the side of the friction lining carrier 64 facing the pressure plate 20 has a ring-like surface 84, which is essentially flat and therefore orthogonal to the axis of rotation A. As shown in FIGS. 5 and 6, the pressure plate 20 has an actuating surface 86 opposing the surface 84 of the pressure plate 20. The blade area 28 of the pressure plate 20 is arranged on a first axial side 88 of the pressure plate 20 and the actuating surface 86 is arranged on the second axial side 90 of the pressure plate 20. The detailed view in FIG. 6 shows that this actuating surface 86 of the pressure plate 20 is shaped such that when the pressure plate 20 is in the relaxed state, i.e., a state in which, for example, it is not being acted upon by the diaphragm spring 26, the actuating surface 86 does not have a flat orientation orthogonal to the axis of rotation A corresponding to the form of the surface 84. Instead, in the example show here, it has a slightly conical shape and thus has a surface normal which is not parallel to the axis of rotation A. The conicity or tapered structure of this actuating surface 86 is such that the radially outer area of the actuating surface 86 of the pressure plate 20 is closer to the surface 84 of the friction lining carrier 64 than the radially inner area. During the course of a clutch-engaging operation, therefore this shape of the pressure plate 20, which is made of, for example, steel or titanium, causes the pressure plate 20 to exert force initially only on the radially outer part of the friction lining carrier 64. As the force being exerted on the pressure plate 20 by the diaphragm spring 26 increases, the pressure plate 20 becomes increasingly deformed and tensioned until its radially inner area also rests against the surface 84. Thus the entire actuating surface 86 of the pressure plate 20 arrives in contact with the friction lining carrier 64, and the actuating surface 86 assumes the same shape as that of the surface 84. If, for example, this surface 84 were also conical, the pressure plate 20 would still come to rest by essentially its entire surface against the surface 84 of the friction lining carrier 64 under the effect of the force being exerted on it by the diaphragm spring 26. An elastic or spring function is thus incorporated into the pressure plate 20, which takes over the function of the elastic suspension of the friction linings in conventional friction clutches or clutch disks and helps to prevent the torque from increasing with a jerk as the clutch is being engaged.

Because the friction disk 36 has friction lining elements 70 only on the axial side immediately adjacent to the pressure plate 20, this friction disk 36 suffers from the basic problem that, at high rpm's, the disk is disposed to bulge outward in response to the centrifugal forces acting on the friction lining elements 70. In the diagram according to FIG. 3, the friction disk 36 tends to bulge out such that its radially inner area moves toward the left, i.e., away from the opposing actuating surface 86 of the pressure plate 20. This would represent a fundamental problem when a friction clutch of this type is released at high rpm's, because then, in the absence or near-absence of the axial clamping force, the friction disk 36 would be free to deform as it will and thus to fill up all or at least some of the axial space which would otherwise be available for the axial displacement of the pressure plate during the clutch-release operation. Because this axial expansion would interfere with the operating characteristics of the clutch during the release phase, the friction disk 36 in the friction clutch 10 according to the invention is connected to the pressure plate 20. This is explained in detail in the following by reference to the detailed view shown in FIG. 6.

FIG. 6 shows one of several (6 are shown in the example in the FIGS.) connecting elements arranged in succession around the circumference and which are designed in the form of stepped rivets 92. Each of the stepped rivets 92 has a section 94 of smaller diameter, which passes through an associated opening 96 in the friction lining carrier 64. Axially adjacent to this section 94 of smaller diameter is a section 98 of larger diameter. The section 98 of larger diameter and a first head 100 of the stepped rivet 92 grip the friction lining carrier 64 from both sides, so that the stepped rivet 92 is clamped or held tightly on the friction lining carrier 64 with essentially no play. It would be possible in principle for the rivets also to be positioned in the area of the friction lining elements 70 if the side of the friction lining elements 70 included an indentation or recess for receiving the first head 100.

The section 98 of larger diameter passes through an associated opening 102 in the pressure plate 20, where a slight amount of play is present. A head 104 is also attached to this section 98 of larger diameter. The head 104 grips the first axial side 88 of the pressure plate 20. FIG. 6 illustrates the previously mentioned relaxed state of the pressure plate 20, in which, primarily in the radially inner area, the actuating surface 86 is a certain axial distance away from the surface 84 of the friction lining carrier 64. The axial dimension of the section 98 of larger diameter is preferably such that, in the completely relaxed state of the pressure plate 20, the head 104 of the rivet rests under only slight load or possibly with play against the first axial side 88 of the pressure plate 20. As a result, the friction disk 36 is provided with axial support against the pressure plate 20 and is therefore prevented from moving away from the actuating surface 86 of the pressure plate 20 (see FIG. 6). The stepped rivet 92 prevents centrifugal forces acting on the friction disk 36 from causing the radially inner area of the friction disk 36 to move away from the pressure plate 20. This allows the clutch to be brought into a released state in a defined manner, even at very high rpm's. During engagement of the clutch, the play provided between the stepped rivet 92 in the area of its section 98 of larger diameter and the pressure plate 20 in the area of the opening 102 allows the pressure plate 20 to become deformed as previously described, until the actuating surface 86 of the pressure plate 20 comes to rest against the surface 84 of the friction disk 36. This state of the pressure plate 20 corresponds to the engaged state of the friction clutch 10 in which there is no longer any danger that the friction disk 36 could bulge outward. Accordingly, the fact that the head 104 of the rivet 92 is a certain distance away from the axial side 88 of the pressure plate 20 in the tensioned state has no disadvantageous effects.

According to the present invention, the stability of the pressure plate 20 can be utilized to exercise a support function for the friction disk 36. This is enabled especially by the feature that the friction disk 36 directly adjacent to the pressure plate 20 is connected directly to the pressure plate 20. As a result, a comparatively thin plate material may be used for the friction lining carrier 64 of the friction disk. When a pressure plate which is slightly conical in the relaxed state is used, that is, a pressure plate with an axial dimension which is larger in the relaxed state than in the tensioned state, the connection according to the invention between the friction disk and the pressure plate, centrifugal forces may cause the friction disk to deform as a result of the connection between the friction disk and the pressure plate. The only effect which this deformation could have is that the pressure plate would be unable to relax quite as much as it could otherwise during the transition to the disengaged state. Any bulging or deformation of the friction disk which might be caused by centrifugal forces therefore cannot have the effect of taking up additional axial space.

If the pressure plate 20 is not designed with a conical or tapering actuating surface but rather with a surface which is essentially orthogonal to the axis of rotation, then the pressure plate 20 will not undergo any deformation during clutch-engaging and disengaging operations. In this case, the connecting elements which serve to connect the pressure plate 20 to the friction disk 36 could also be used to provide an axially tight joint without any play. Here, then, conventional clinch bolts or the like, for example, could be used to establish the connection. The principles of the present invention are applicable even when an intermediate disk or the like is provided between the pressure plate 20 and the immediately adjacent friction disk 36 or the friction lining carrier 64 of that disk. In this case, the intermediate disk would then be held firmly in place between the pressure plate 20 and the friction disk 36 by the connecting elements or stepped rivets 92.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A friction clutch, comprising:
a housing arrangement connectable to a drive element for rotation about an axis of rotation;
a pressure plate having a first axial side and a second axial side, said pressure plate being connected to the housing arrangement such that the pressure plate is fixed with respect to rotation relative to said housing arrangement and is axially movable relative to said housing arrangement;
a force-exerting arrangement arranged between said housing arrangement and said pressure plate, said force exerting arrangment acting on said first axial side of said pressure plate to produce an engaged state of said friction clutch and liftable from said pressure plate to produce a disengaged state of said friction clutch; and
a friction disk connected to said housing arrangement such that said friction disk is fixed with respect to rotation relative to said housing arrangement and axially movable relative to said housing arrangement, said second axial side of said pressure plate acting on said friction disk in the engaged state of said friction clutch, said friction disk including a ring-shaped friction lining carrier carrying at least one friction lining element on an axial side of said friction lining carrier facing way from said pressure plate,
wherein said friction disk is connected to said pressure plate for limiting movement of said friction disk in the direction away from said second axial side of said pressure plate.

2. The friction clutch of claim 1, wherein said pressure plate has an actuating surface on said second axial side facing one of said friction disk and an element arranged between said second axial side and said friction disk, at least an area of said actuating surface has a surface normal that is not parallel to the axis of rotation when the force-exerting arrangement is not acting on said pressure plate, and wherein said friction disk is connected to said pressure plate such that said friction disk is movable relative to said pressure plate, said pressure plate being deformable between a tensioned state, in which said force-exerting arrangement acts on said pressure plate and said actuating surface assumes the same shape as that of one of said friction disk and an element between said second axial side and said friction disk, and a relaxed state, in which said force-exerting arrangement is not acting on the pressure plate.

3. The friction clutch of claim 2, further comprising a plurality of connecting elements for connecting said friction lining carrier to said pressure plate.

4. The friction clutch of claim 3, wherein said connecting elements are rigidly connected to said friction lining carrier but allow relative movement between said pressure plate and said friction lining carrier.

5. The friction clutch of claim 4, wherein said connecting elements are supported in the axial direction against said pressure plate when said pressure plate is in the relaxed state.

6. The friction clutch of claim 5, wherein at least one of said connecting elements is a stepped rivet having a first head connected to a section of smaller diameter which passes through said friction lining carrier, a section of larger diameter adjacent to said section of smaller diameter and which passes through said pressure plate, wherein said friction lining carrier is held firmly in place between the section of larger diameter and said first head of said stepped rivet, and wherein a second head of said stepped rivet adjacent to said section of larger diameter and supported on said first axial side of said pressure plate.

7. The friction clutch of claim 1, further comprising a plurality of friction disks connected to said housing arrangement such that said plurality of frictions disks are fixed with respect to rotation relative to said housing arrangement and axially movable relative to said housing arrangement, a hub rotatable about said axis of rotation, and at least one further friction disk connected to said hub such that said at least one further disk is fixed with respect to rotation and axially movable relative to said hub, wherein said at least one further disk is always located between two of said plurality of friction disks connected to said housing arrangement.

8. The friction clutch of claim 7, wherein at least one friction disk of said plurality of friction disks connected to said housing arrangement has a ring-shaped friction lining carrier and friction lining elements attached to both axial sides.

9. The friction clutch of claim 1, wherein said force-exerting arrangement comprises an energy-storage device supported against said pressure plate and said housing arrangement.

10. The friction clutch of claim 2, wherein said actuating surface is conical.

11. The friction clutch of claim 1, further comprising a plurality of connecting elements for connecting said friction lining carrier to said pressure plate.

12. The friction clutch of claim 11, wherein said connecting elements are rigidly connected to said friction lining carrier but allow relative movement between said pressure plate and said friction lining carrier.
